(19) United States
(12) Patent Application Publication
(10) Pub. No.: US 2005/0254059 A1
(43) Pub. Date: Nov. 17, 2005

(54) Low coherence interferometric system for optical metrology

(76) Inventor: Gerard A. Alphonse, Princeton, NJ (US)

Correspondence Address: CANTOR COLBURN, LLP, 55 GRIFFIN ROAD SOUTH, BLOOMFIELD, CT, 06002, US

(21) Appl. No.: 10/846,445

(22) Filed: May 14, 2004

(51) Int. Cl. G01B 9/02

(52) U.S. Cl. 356/479

(57) ABSTRACT

A system for optical metrology of a biological sample comprising: a broadband light source; an optical assembly receptive to the broadband light, the optical assembly configured to facilitate transmission of the broadband light in a first direction and impede transmission of the broadband light a second direction; a sensing light path receptive to the broadband light from the optical assembly; a fixed reflecting device; a reference light path receptive to the broadband light from the optical assembly, the reference light path coupled with the sensing light path, the reference light path having an effective light path length longer than an effective light path length of the sensing light path by a selected length corresponding to about a selected target depth within the biological sample; and a detector receptive the broadband light resulting from interference of the broadband light to provide an electrical interference signal indicative thereof.

### BACKGROUND

The invention concerns a low coherence interferometric system for optical metrology of biological samples. The term “biological sample” denotes a body fluid or tissue of an organism. Biological samples are generally optically heterogeneous, that is, they contain a plurality of scattering centers scattering irradiated light. In the case of biological tissue, especially skin tissue, the cell walls and other intra-tissue components form the scattering centers.

Generally, for the qualitative and quantitative analysis in such biological samples, reagents or systems of reagents are used that chemically react with the particular component(s) to be determined. The reaction results in a physically detectable change in the solution of reaction, for instance a change in its color, which can be measured as a measurement quantity. By calibrating with standard samples of known concentration, a correlation is determined between the values of the measurement quantity measured at different concentrations and the particular concentration. These procedures allow accurate and sensitive analyses, but on the other hand they require removing a liquid sample, especially a blood sample, from the body for the analysis (“invasive analysis”).

Monitoring and evaluating a biological sample facilitates analysis and diagnosis for patients and research. Accordingly, a number of procedures and systems have been employed. Optical monitoring techniques are particularly attractive in that they are relatively fast, use non-ionizing radiation, and generally do not require consumable reagents.

U.S. Pat. No. 6,226,089 to Hakamata discloses a system for detecting the intensities of backscattering light generated by predetermined interfaces of an eyeball when a laser beam of low coherence emitted from a semiconductor laser is divided into two parts, a signal light beam and a reference light beam, which travel along two different optical paths. At least one of the signal light beam and the reference light beam is modulated in such a way that a slight frequency difference is produced between them. The signal light beam is projected onto an eyeball, which has been in a predetermined position, and first backscattering light of the signal light beam generated by the interface between the cornea and the aqueous humor is caused to interfere with the reference light beam by controlling the length of the optical path of the reference light beam. The intensity of first interference light obtained by the interference between the first backscattering light and the reference light beam is measured and the intensity of the first backscattering light is determined. The absorbance or refractive index of the aqueous humor in the anterior chamber of the eyeball is determined on the basis of the intensities of the backscattering light. Light scattering effects are evident in the near-infrared range, where water absorption is much weaker than at larger wavelengths (medium- and far-infrared). However, techniques that rely on the backscattered light from the aqueous humor of the eye are affected by optical rotation due to cornea, and by other optically active substances. In addition, other interfering factors include saccadic motion, corneal birefringence, and time lag between analyte changes of the desired biological sample and the intra-ocular fluids.

Low-Coherence Interferometry (LCI) is another technique for analyzing light scattering properties of a biological sample. Low Coherence Interferometry (LCI) is an optical technique that allows for accurate, analysis of the scattering properties of heterogeneous optical media such as biological tissue. In LCI, light from a broad bandwidth light source is first split into sample and reference light beams which are both retro-reflected, from a targeted region of the sample and from a reference mirror, respectively, and are subsequently recombined to generate an interference signal. Characteristics of the interference signal are the exploited to facilitate analysis of the sample. Constructive interference between the sample and reference beams occurs only if the optical path difference between them is less than the coherence length of the source.

U.S. Pat. No. 5,710,630 to Essenpreis et al. describes a glucose measuring apparatus for the analytical determination of the glucose concentration in a biological sample and comprising a light source to generate the measuring light, light irradiation means comprising a light aperture by means of which the measuring light is irradiated into the biological sample through a boundary surface thereof, a primary-side measuring light path from the light source to the boundary surface, light receiving means for the measuring light emerging from a sample boundary surface following interaction with said sample, and a secondary-side sample light path linking the boundary surface where the measuring light emerges from the sample with a photodetector. The apparatus being characterized in that the light source and the photodetector are connected by a reference light path of defined optical length and in that an optic coupler is inserted into the secondary-side measurement light path which combines the secondary-side measuring light path with the reference light path in such manner that they impinge on the photodetector at the same location thereby generating an interference signal. A glucose concentration is determined utilizing the optical path length of the secondary-side measuring light path inside the sample derived from the interference signal.

### BRIEF SUMMARY

The abovementioned and other drawbacks and deficiencies of the prior art are overcome or alleviated by the measurement system and methodology disclosed herein. Disclosed herein in an exemplary embodiment is a system for optical metrology of a biological sample. The system comprises: a broadband light source for providing a broadband light; an optical assembly receptive to the broadband light, the optical assembly configured to facilitate transmission of the broadband light in a first direction and impede transmission of the broadband light a second direction, and the optical assembly generally maintaining low coherence of the broadband light. The system also includes: a sensing light path receptive to the broadband light from the optical assembly, the sensing light path configured to direct the broadband light at the biological sample and to receive the broadband light reflected from the biological sample; a fixed reflecting device; a reference light path receptive to the broadband light from the optical assembly, the reference light path configured to direct the broadband light at the fixed reflecting device and to receive the broadband light reflected from the fixed reflecting device, the reference light path coupled with the sensing light path to facilitate interference of the broadband light reflected from the biological sample and the broadband light reflected from the fixed reflecting device, the reference light path having an effective light path length longer than an effective light path length of the sensing light path by a selected length corresponding to about a selected target depth within the biological sample; and a detector receptive the broadband light resulting from interference of the broadband light reflected from the biological sample and the broadband light reflected from the fixed reflecting device to provide an electrical interference signal indicative thereof.

Also disclosed herein in an exemplary embodiment is a method for optical metrology of a biological sample, the method comprising: providing a broadband light by means of a broadband light source; facilitating transmission of the broadband light in a first direction and impeding transmission of the broadband light a second direction, while generally maintaining low coherence of the broadband light; directing the broadband light by means of a sensing light path at the biological sample, the sensing light path having an effective light path length; and receiving the broadband light reflected from the biological sample by means of the sensing light path. The method also includes directing the broadband light by means of a reference light path at a fixed reflecting device, the reference light path having an effective light path length, the effective light path length of the reference light path being longer than the effective light path length of the sensing light path by a selected length corresponding to about a selected target depth within the biological sample. The method further includes: receiving the broadband light reflected from the fixed reflecting device by means of the reference light path; interfering the broadband light reflected from the biological sample and the broadband light reflected from the fixed reflecting device; and detecting the broadband light resulting from interference of the broadband light reflected from the biological sample and the broadband light reflected from the reflecting device to provide an electrical interference signal indicative thereof.

Also disclosed herein in another exemplary embodiment is a system for optical metrology of a biological sample, the system comprising: a means for providing a broadband light by means of a broadband light source; a means for facilitating transmission of the broadband light in a first direction and impeding transmission of the broadband light a second direction, while generally maintaining low coherence of the broadband light; and a means for directing the broadband light by means of a sensing light path at the biological sample, the sensing light path having an effective light path length. The system also includes a means for receiving the broadband light reflected from the biological sample by means of the sensing light path; a means for directing the broadband light by means of a reference light path at a fixed reflecting device, the reference light path having an effective light path length, the effective light path length of the reference light path being longer than the effective light path length of the sensing light path by a selected length corresponding to about a selected target depth within the biological sample. The system further includes: a means for receiving the broadband light reflected from the fixed reflecting device by means of the reference light path; a means for interfering the broadband light reflected from the biological sample and the broadband light reflected from the fixed reflecting device; and a means for detecting the broadband light resulting from interference of the broadband light reflected from the biological sample and the broadband light reflected from the reflecting device to provide an electrical interference signal indicative thereof.

Also disclosed herein in yet another exemplary embodiment is a storage medium encoded with a machine-readable computer program code, the code including instructions for causing a computer to implement the abovementioned method for optical metrology of a biological sample.

Further disclosed herein in another exemplary embodiment is a computer data signal, the computer data signal comprising code configured to cause a processor to implement the abovementioned method for optical metrology of a biological sample.

### BRIEF DESCRIPTION OF THE DRAWINGS

These and other features and advantages of the present invention may be best understood by reading the accompanying detailed description of the exemplary embodiments while referring to the accompanying figures wherein like elements are numbered alike in the several figures in which:

FIG. 1 is a basic all-fiber low-coherence interferometer (LCI);

FIG. 2 depicts a plot of the envelope function G(□1) and of the interference signal G(□1) cos □s;

FIG. 3 depicts a range of unambiguous measurement for a periodic interference signal;

FIG. 4A depicts a minimum configuration interferometer system in accordance with an exemplary embodiment of the invention;

FIG. 4B depicts a configuration of an interferometer system in accordance with an exemplary embodiment of the invention;

FIG. 5 depicts an illustration of a splitter-modulator module in accordance with an exemplary embodiment;

FIG. 6A depicts a process for fabricating the splitter-modulator module in accordance with an exemplary embodiment;

FIG. 6B depicts a process of fabricating the splitter-modulator module in accordance with an exemplary embodiment;

FIG. 6C depicts a process of fabricating the splitter-modulator module in accordance with an exemplary embodiment;

FIG. 7 depicts a miniaturized, handheld LCI system in accordance with an exemplary embodiment;

FIG. 8A depicts operation of a miniaturized, handheld LCI system in accordance with an exemplary embodiment;

FIG. 8B depicts operation of a miniaturized, handheld LCI system in accordance with another exemplary embodiment;

FIG. 9 depicts an adaptation of the interferometer system of FIGS. 4A and 4B with a calibration strip;

FIG. 10A depicts an interface for extension modules in accordance with another exemplary embodiment of the invention;

FIG. 10B depicts an interface for extension in accordance with another exemplary embodiment of the invention;

FIG. 10C depicts another interface for extension in accordance with yet another exemplary embodiment of the invention;

FIG. 11 depicts an adaptation of the interferometer system of FIGS. 4A and 4B for ranging measurements in accordance with another exemplary embodiment; and

FIG. 12 depicts another adaptation of the interferometer system of FIGS. 4A and 4B for ranging measurements in accordance with yet another exemplary embodiment with external probe.

### DETAILED DESCRIPTION OF AN EXEMPLARY EMBODIMENT

Disclosed herein, in several exemplary embodiments are high-sensitivity low coherence interferometric (LCI) systems (instruments) for optical metrology of biological samples including, but not limited to analytes, lipids, other biological parameters, and the like, such as glucose and plaques. In an exemplary embodiment the LCI systems are miniaturized for use in a variety of sensing and monitoring applications, including, but not limited to, trace chemical sensing, optical properties, medical sensing such as analyte monitoring and evaluation and others. In an exemplary embodiment, the instrument is miniaturized, using integrated optics components such as waveguides, splitters and modulators on a single substrate such as, but not limited to, a LiNbO3 (Lithium Niobate) chip. The exemplary embodiments may also involve the use of a “circulator” type of optical component, including of a polarizing beam splitter and quarterwave plate, which can be combined with the light source and detector into a miniature module that prevents optical feedback into the light source while doubling the detected light. Alternatively, instead of the polarizing beam splitter and quarter wave plate one or more isolators and a waveguide coupler may be employed in a similar module to accomplish the same purpose. Disclosed herein in the exemplary embodiments are multiple methodologies and associated systems employed to derive information from the magnitude and/or phase of an interferometric signal.

It will be appreciated that while the exemplary embodiments described herein are suitable for the analysis in comparatively highly scattering, i.e. optically heterogeneous biological samples, optically homogeneous (that is, low-scattering or entirely non-scattering) samples also may be analyzed provided suitable implementations of the embodiments of the invention are employed. It may be further appreciated that the methods discussed herein may not permit an absolute measurements of a characteristic of a sample, but rather a relative measurement from a given baseline. Therefore, calibration to establish a baseline may be required. For instance, for one exemplary embodiment, a calibration strip of known refractive index is employed to facilitate calibration. Other methodologies, such as using a sample of known index of refraction, or known properties may also be employed.

It should noted that the light wavelengths discussed below for such methods are in the range of about 300 to about several thousand nanometers (nm), that is in the spectral range from near ultraviolet to near infrared light. In an exemplary embodiment, for the sake of illustration, a wavelength of about 1300 nm is employed. The term “light” as used herein is not to be construed as being limited or restricted to the visible spectral range.

It will also be noted that for a homogeneously scattering medium for which a specific property, such as the refractive index, is to be measured, it may be sufficient to probe at a single depth. In such instances, the desired information can be obtained from the phase of the interferometric signal, substantially independent of the amplitude. Therefore, an instrument as described herein in the simplest configuration of an exemplary embodiment is configured for measurement at a single depth. However, if desired, to probe for inhomogeneities (local changes of absorption, reflection, or refractive index), the instrument may be configured to measure both the amplitude and the phase of the interferometric signal as functions of depth. Described herein in a first exemplary embodiment is a system configured to probe at a fixed depth, while later embodiments may be employed for measurement at variable depths and for general imaging purposes. In any case, emphasis is placed on miniaturization, portability, low power and low cost.

Finally, it will also be appreciated that while the exemplary embodiments disclosed herein are described with reference and illustration to analyte determinations, applications and implementations for determination of other analytes may be understood as being within the scope and breadth of the claims. Furthermore, the methodology and apparatus of several exemplary embodiments are also non-invasive, and thereby eliminate the difficulties associated with existing invasive techniques.

Another important consideration is that, as a tool, particularly for medical diagnostic applications, the LCI system of the exemplary embodiments is preferably configured to be easily portable, and for use by outpatients it must be small. Moreover, the LCI system 10 is configured to be readily hand-held to facilitate convenient measurements by a patient without additional assistance in any location.

Similarly, applications and implementations that are invasive may also be readily employed with the appropriate configurations. For example, when implemented with an extensible fiber/guidewire and catheter arrangement or the like, the embodiments disclosed herein may readily be adapted for invasive applications.

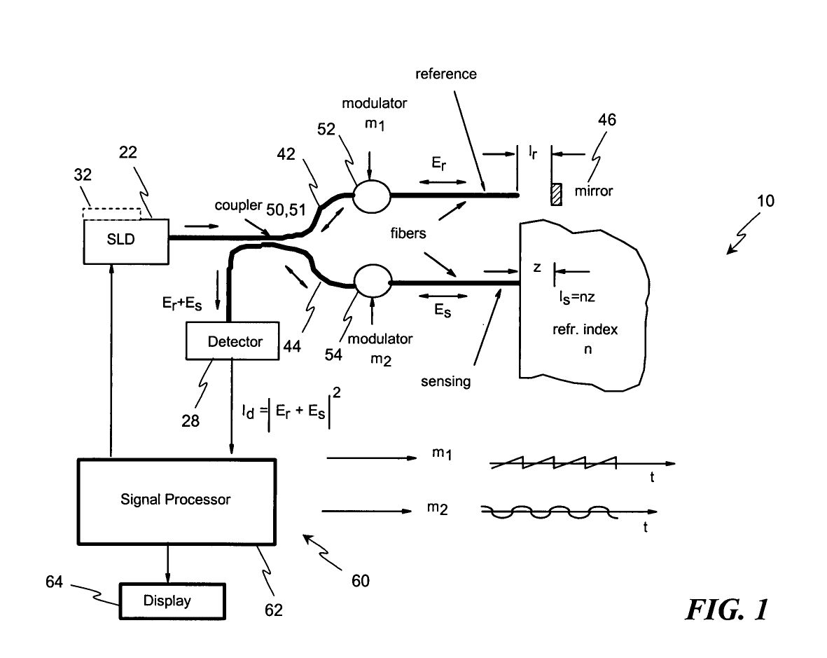

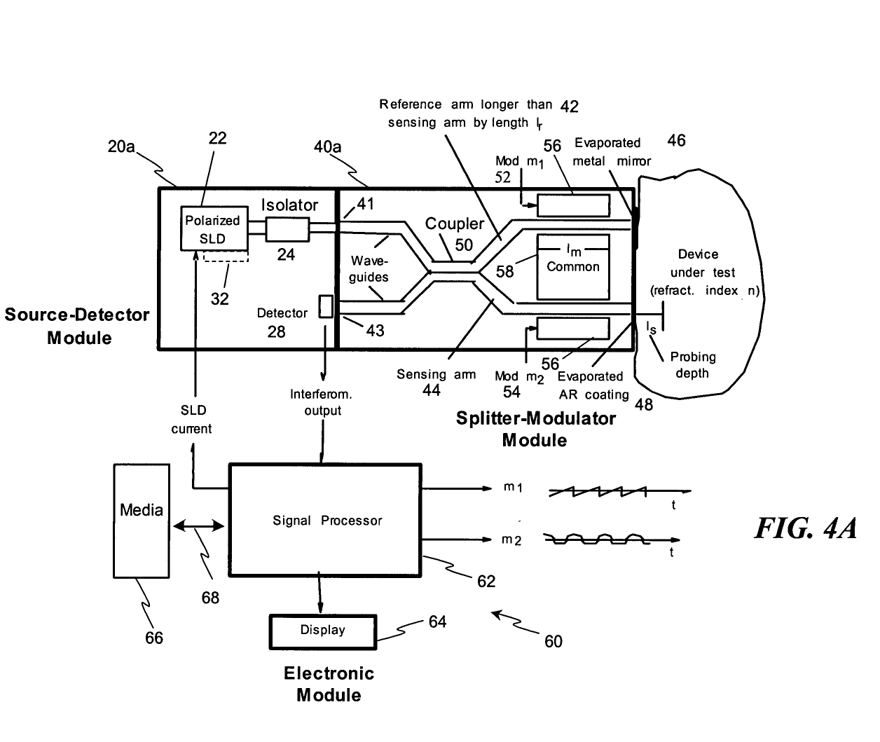

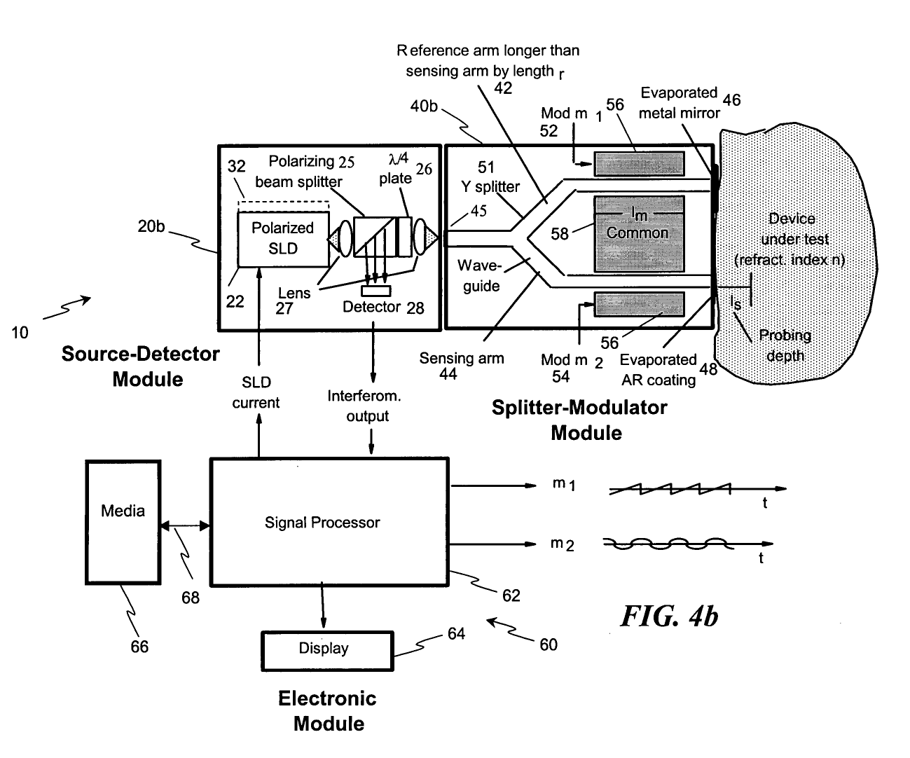

To facilitate appreciation of the various embodiments of the invention reference may be made to FIG. 1, depicting an all-fiber low-coherence interferometer (LCI) system and the mathematical equations developed herein. Referring also to FIG. 4A, in an exemplary embodiment, an LCI system 10 includes, but is not limited to two optical modules: a source-detector module 20a and a splitter-modulator module 40a, and associated processing systems 60. The source-detector module 20a including, but not limited to, a broad-band light source 22, such as a super luminescent diode (SLD) denoted hereinafter as source or SLD, attached to a single-mode fiber 23 or waveguide, an isolator 24 configured to ensure that feedback to the broad band light source 22 is maintained at less than a selected threshold. The source-detector module 20a also includes an optical detector 28.

The splitter-modulator module 40a includes, but is not limited to, a waveguide input 41, a waveguide output 43, a splitter/coupler 50, and two waveguide light paths: one light path, which is denoted as the reference arm 42, has adjustable length lr with a reflecting device, hereinafter a mirror 46 at its end; the other light path, which is denoted as the sensing arm 44, allows light to penetrate to a distance z in a medium/object and captures the reflected or scattered light from the medium. It will be appreciated that the captured reflected or scattered light is likely to be only the so-called “ballistic photons”, i.e., those that are along the axis of the waveguide. Provision is also made for one or more modulators 52, 54 in each of the reference arm 42 and sensing arm 44 respectively.

Continuing with FIG. 4B as well, in another exemplary embodiment, the source-detector module 20b includes, but is not limited to, a polarized broad-band light source 22, attached to a single-mode fiber 23. The source-detector module 20b also includes a polarizing beam splitter 25 with an quarter wave plate 26 employed to ensure a selected polarization configured to facilitate ensuring that feedback to the broad band light source 22 is maintained at less than a selected threshold. The source-detector module 20b also includes an optical detector 28.

The splitter-modulator module 40b of this embodiment includes, but is not limited to, a waveguide inputs/output 45, a Y-splitter-combiner 51, and the two waveguide arms: reference arm 42, and sensing arm 44. Once again, provision is also made for one or more modulators 52, 54 in each of the reference arm 42 and sensing arm 44 respectively.

It will be appreciated that while certain components have been described as being in selected modules, e.g., 20, 40, such a configuration is merely illustrative. The various components of the LCI system 10 may readily be distributed in one or more various modules e.g., 20, 40 as suits a given implementation or embodiment. Furthermore, in an exemplary embodiment the waveguide arms 42, 44 and/or fibers 23 are configured for single-transverse-mode transmission, and preferably, but not necessarily, polarization-maintaining waveguides or fibers. Furthermore it will be appreciated that in any of the exemplary embodiments disclosed herein the waveguide and/or fiber tips of each component joined are configured e.g., angled-cleaved in a manner to minimize reflection at the junctions.

In order to perform the prescribed functions and desired processing, as well as the computations therefore (e.g., the computations associated with detecting and utilizing the interference signal, and the like), the LCI system 10, and more particularly, the processing system 60, may include, but is not limited to a computer system including central processing unit (CPU) 62, display 64, storage 66 and the like. The computer system may include, but not be limited to, a processor(s), computer(s), controller(s), memory, storage, register(s), timing, interrupt(s), communication interface(s), and input/output signal interfaces, and the like, as well as combinations comprising at least one of the foregoing. For example, computer system may include signal input/output for controlling and receiving signals from the source-detector module 20 as described herein. Additional features of a computer system and certain processes executed therein may be disclosed at various points herein.

The processing performed throughout the LCI system 10 may be distributed in a variety of manners as will also be described at a later point herein. For example, distributing the processing performed in one ore more modules and among other processors employed. In addition, processes and data may be transmitted via a communications interface, media and the like to other processors for remote processing, additional processing, storage, and database generation. Such distribution may eliminate the need for any such component or process as described or vice versa, combining distributed processes in a various computer systems. Each of the elements described herein may have additional functionality that will be described in more detail herein as well as include functionality and processing ancillary to the disclosed embodiments. As used herein, signal connections may physically take any form capable of transferring a signal, including, but not limited to, electrical, optical, or radio.

The light reflected from the reference mirror 46 (Electric field E,) in the reference arm 42 and the light reflected or scattered from depth z within the biological sample (Electric field Eₛ) in the sensing arm 44 are combined at the optical detector 28, whose output current is proportional the combined electric fields. For example, in one instance, the output of the detector is proportional to the squared magnitude of the total electric field Eₜ=Eᵣ+Eₛ.

The detector current I_{d} is given by:
I_{d}=|Eᵣ+Eₛ|²=Iᵣ+Iₛ+2\sqrt{IᵣIₛ}|G(τ)| cos 2πv₀τ, (1)
where η is the detector quantum efficiency (typically <1), Iᵣ=ηE_{r*}Eᵣ* is the detector current due to Eᵣ alone, Iₛ=ηE_{s*}Eₛ* is the detector current due to Eₛ alone, and the * represents the complex conjugate. E_{r*}Eᵣ* and E_{s*}Eₛ* represent the optical power in the reflected reference field and reflected sensing field, respectively. The quantity π is the time delay between the reference field Eᵣ and sensing field Eₛ, and is given by:

$$τ = \frac{{l}_{r}}{c} - \frac{z}{c / n} = \frac{{l}_{r} - {l}_{s}}{c} = \frac{Δ l}{c} \qquad ( 2 )$$

where lₛ=nz and Δl=lᵣ−lₛ and where Δl is the optical path difference between the reference lᵣ and sensing lₛ arms 42, 44, z is the selected or desired target depth in the biological sample, n is the index of refraction in the sample, and c is the speed of light. Also in Equation (1), v₀ is the center frequency of the light source 22, and G(τ) it the cross-correlation function between the reference and sensing fields. Its magnitude is given by:

$$\vert G ( τ ) \vert = exp [ - {( \frac{πΔ v τ}{2 \sqrt{ln 2}} )}^{2} ] \qquad ( 3 )$$

where Δv is the FWHM (full width half maximum) frequency bandwidth of the light source 22.

The last term in Equation (1), the interference term, is the quantity of interest denoted as i₀:
i₀(τ)=2\sqrt{IᵣIₛ}|G(τ)| cos 2πv₀τ (4)

It is convenient to express the interference term i₀, in terms of the center wavelength λ₀ and the path difference al associated with the interferometer, instead of the frequency and time delay. Therefore, using v₀λ₀=c, where c is the speed of light in vacuum, Δv may be written in terms of the wavelength FWHM bandwidth Δλ, to obtain:

$$\begin{matrix}{i}_{o} ( Δ l ) = 2 \sqrt{{I}_{r} {I}_{s}} \vert G ( Δ l ) \vert cos {ϕ}_{s} where {ϕ}_{s} = \frac{2 π}{{λ}_{o}} Δ l \\ and & ( 5 ) \\ \vert G ( Δ l ) \vert = exp [ - {( \frac{Δ l}{{L}_{c}} )}^{2} ] & ( 6 )\end{matrix}$$

where L_{c} is the coherence length of the light source and is given by

$${L}_{c} = \frac{2 \sqrt{ln 2}}{π} \frac{{λ}_{o}^{2}}{Δλ} = 0.44 \frac{{λ}_{o}^{2}}{Δλ} . \qquad ( 7 )$$

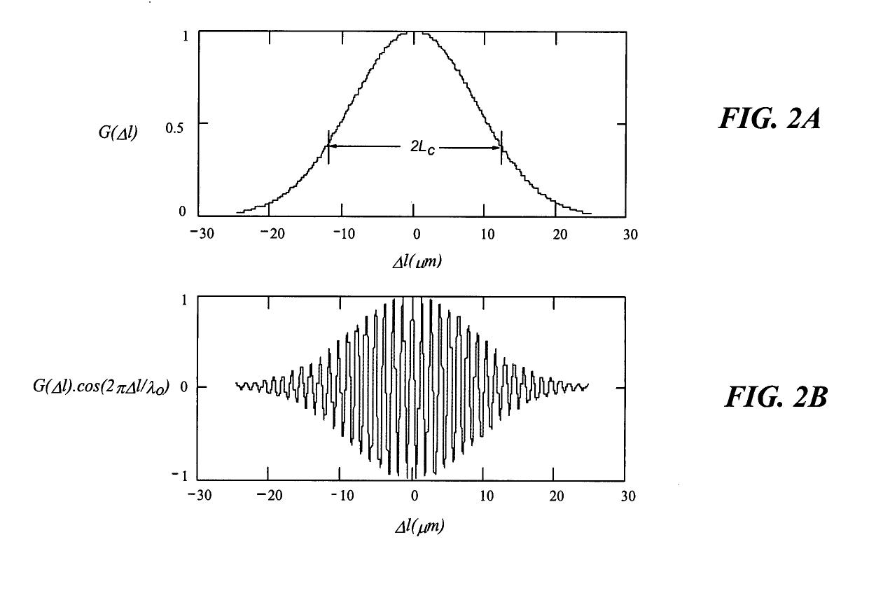

A plot of the envelope function G(Δl) and if the interference signal G(Δl)cos φₛ is shown in FIGS. 2A and 2B respectively, for an interferometer with a light source 22 having center wavelength λ₀=1.3 μm and FWHM bandwidth Δλ=60 nm (coherence length L_{c}=12.4 μm). The detected interference signal exhibits a maximum when the interferometer is balanced, i.e., when the path difference Δl=0. As the system 10 becomes increasingly unbalanced, e.g., Δl≠0, the interference signal exhibits maxima and minima of decreasing amplitude over a range determined by Δl.

It will be appreciated that the interference signal i₀ exhibits significant amplitude only over a spatial window of approximately twice the coherence length L_{c}. As the optical bandwidth increases, the coherence length L_{c} decreases and the spatial measurement window narrows. Thus, LCI provides a means for probing samples at precisely defined locations within the sample.

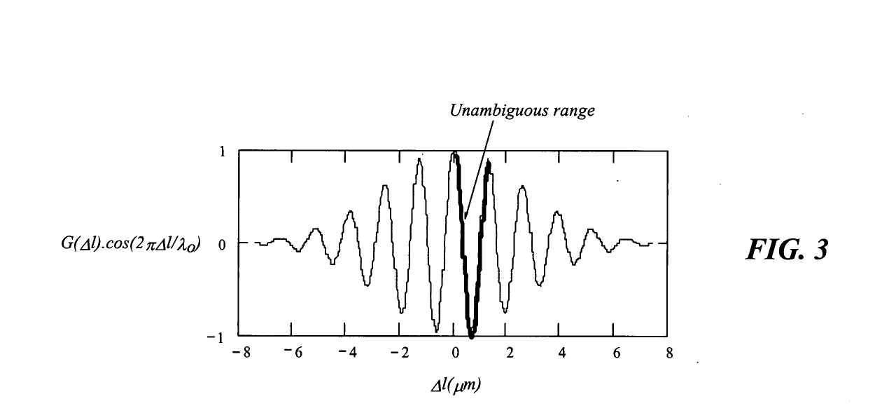

It is noteworthy to appreciate that the phase, φₛ, of the interference signal i₀ changes by 2π (from a maximum to a minimum then to another maximum) as Δl varies from 0 to λ₀. Therefore, a small change in Δl results in a large phase change. It will be further appreciated that the phase of the interference signal i₀ is highly sensitive to small changes of optical properties of the mediums, such as refractive indices, or depth z. Thus, while moderate to large changes may readily be observed by measuring the magnitude of the envelope G(Δl), small changes are best detected by measuring the phase φₛ of the interference signal i₀. It will be further appreciated that all the desired information is contained in the range from 0 to 2π. For values of Δl>λ₀, the interference signal i₀ is repetitive. Thus, the range from 0 to 2π as indicated in FIG. 3 is a range for which the desired information can be measured without ambiguity. It may also be noted however, that if the coherence length L_{c} is short enough that the amplitude difference between the main peak and secondary peaks is measurable, then phase measurement beyond 2π may be realized.

Therefore, it will be readily be appreciated that there are two types of information, which can be derived from the interference signal i₀: the envelope G(Δl), or its peak G(Δl=0), which may represent scattering, reflection, and absorption; and the more sensitive changes in cost due to small optical property changes in the sample. In order to make any such measurements, it is first preferable to separate the DC components Iᵣ and Iₛ from G(Δl) and cos φₛ in the interferometric signal i₀ described in Equation (5).

Referring once again to FIGS. 4A and 4B, broadband light sources including, but not limited to, SLD's are laser type structures configured and designed to operate substantially without feedback, e.g., of the order of less than 10⁻³, preferably less than 104, more preferably less than 10⁻⁵. In the presence of feedback, the spectrum of the SLD light source 22 may be distorted, the coherence is significantly increased and the spectrum can exhibit very large ripples and even lasing spikes, and thereby may become lasers. Therefore, to prevent distortion and maintain spectral integrity, low coherence, and broadband characteristics, reflections back into the light source 22 are avoided to maintain a broadband light source 22. Thus, in an exemplary embodiment of the LCI system, isolation is provided to alleviate feedback to the light source 22.

Continuing with FIGS. 4A and 4B, in an exemplary embodiment, the source-detector module 20a, 20b, is configured to prevent the reflected interferometer light from reaching the SLD light source 22 and upsetting its operation. The SLD source 22 is designed and configured such that it is linearly-polarized. SLDs and lasers are “heterostructures” semiconductor devices consisting of a thin “active” layer sandwiched between two “cladding” layers of lower refractive index, all epitaxially grown on a single crystal substrate 23. One such process for fabrication is known as MOCVD (metalorganic chemical vapor deposition). One of the cladding layers is p-doped, and the other is n-doped. The substrate 23 is typically n-doped, and the n-cladding layer is the first to be deposited on it. The structure forms a p-n semiconductor junction diode, in which the active layer is caused to emit light of energy equal to its bandgap upon the application of an electric current.

The structure is called heterostructure because the active and clad layers are made of different material. This is in contrast with ordinary diodes in which the p-n junction is formulated between similar materials of opposite doping. The use of heterostructure has made it possible to confine the electrical carriers to within the active region, thus providing high efficiency and enabling operation at room temperature. In many heterostructures, light is emitted in both TE polarization (the electric field in the plane of the layer) and TM polarization (electric field perpendicular to the layer).

However, useful effects are obtained when the active layer is sufficiently thin such that quantum mechanical effects become manifest. Such thin layers are called “quantum well” (QW) layers. Furthermore, the active layer can be “strained”, i.e., a slight mismatch (of about 1%) with respect to the substrate crystal lattice can be introduced during the deposition of the QW layer. The strain can modify the transition characteristics responsible for light emission in beneficial ways. In particular, the light is completely polarized in the TE mode if the strain is compressive. Thus, it is now possible to make a linear polarized laser or broadband SLD by compressive strain of the active layer. In an exemplary embodiment, such a linearly-polarized light source 22 is employed.

In one exemplary embodiment, as depicted in FIG. 4A, the light from the light source 22 is directed through an isolator 24 configured to transmit light in one direction, while blocking light in the opposite direction. The light is directed to a splitter/coupler 50 of the splitter-modulator module 40a. The source-detector module 20a also contains a detector 28 to receive from the splitter/coupler 50.

In another exemplary embodiment as depicted in FIG. 4B, the linearly-polarized light from the SLD light source 22 is collimated with lenses 27 and applied to a splitter 25. If a basic 50/50 splitter 24 is employed, half of the returned light goes to the detector 28 and the other half is directed to the SLD light source 22. Once again, in this configuration an isolator 24 may be employed to prevent feedback to the light source 22. Similarly, as stated earlier, in another exemplary embodiment, the splitter 25 is a polarizing beam splitter 25 operating in cooperation with a quarter wave plate 26, employed to prevent feedback light from reaching the light source 22. The polarizing beam splitter 25 facilitates the elimination of feedback to the SLD light source 22 by redirecting substantially all the reflected light from the splitter-modulator module 40b to the detector 28.

The splitter 25 transmits the horizontally polarized light to the quarter wave plate 26, which coverts the light to another polarization, (for example, circular polarization). Likewise, the returning, circularly polarized light is received by the quarter wave plate 26 and is reconverted to a linear polarization. However, the linear polarization opposite, for example, vertical. The vertically polarized light is transmitted to the polarizing beam splitter 25, which directs all of the light to the detector 28. Advantageously, this approach transmits substantially all of the light i.e., the interference signal, to the detector 28. Whereas embodiments employing the isolator 24 transmits approximately half of the light to the detector 28.

The polarizing beam splitter 25 is a device that transmits light of one polarization (say the horizontal, or TE-polarized SLD light) and reflects at 90° any light of the other polarization (e.g., vertical or TM-polarized). The quarter-wave plate 26 is a device that converts a linearly polarized incident light to circular polarization and converts the reflected circularly-polarized light to a linearly-polarized of the other polarization which is then reflected at a 90° angle by the polarizing beam splitter 25 to the detector 28. Therefore, essentially all the light transmitted by the light source 22 is re-polarized and transmitted to the splitter-modulator module 40b and all the reflected light from the sample and reflecting device 48 is deflected by the polarizing beam splitter 25 to the detector 28. Advantageously, this doubles the light received at the detector 28 relative to the other embodiments, and at the same time minimizes feedback to the SLD light source 22.

In an exemplary embodiment an SLD chip for the light source 22 has dimensions of approximately 1 mm×0.5 mm×0.1 mm (length×width×thickness), and emits a broadband light typically of up to 50 mW upon the application of an electric current of the order of 200-300 mA. The light is TE-polarized if the active layer is a compressively strained QW. The FWHM spectrum is of the order of 2% to 3% of the central wavelength emission. A SLD light source 22 with 1.3 μm center wavelength emission and operating at 10 mW output power at room temperature would have a bandwidth of about 40 nm and would require about 200 mA of current. In an exemplary embodiment, for continuous wave (cw) operation at room temperature, the SLD light source 22 may be mounted on an optional thermoelectric cooler (TEC) 32 a few millimeters larger than the SLD light source 22 chip to maintain the temperature of the light source 22 within its specified limits. It will be appreciated that the SLD light source 22 and associated TEC 32 peripherals in continuous operation would have the largest power consumption in the LCI system 10. However, without the TEC 32, the SLD junction temperature would rise by several degrees under the applied current and would operate at reduced efficiency.

Advantageously, in yet another exemplary embodiment, the utilization of a TEC 32 may readily be avoided without incurring the effects of significant temperature rise by pulsed operation of the SLD light source 22. Pulsed operation has the further advantage of reducing the SLD electrical power requirement by a factor equal to the pulsing duty cycle. Moreover, for selected applications of digital technology and storage, only a single pulse is sufficient to generate an interference signal and retrieve the desired information. Therefore, for example, with pulses of duration 10 μs and 1% duty factor, the LCI system 10 of an exemplary embodiment can average 1000 measurements per second without causing the SLD light source 22 temperature to rise significantly. Thus, for low power consumption, the LCI system 10 should preferably be designed for the SLD light source 22 to operate in a pulsed mode with a low duty cycle and without a TEC 32. In such a configuration the source-detector module 20 would be on the order of about 2 centimeters (cm)×2 cm×1 cm.

The splitter-modulator module 40a, and 40b of an exemplary embodiment includes a splitter/coupler 50 and Y-splitter/combiner 51 respectively, with a “reference” arm 42 and a “sensing” arm 44, the reference arm 42 having a slightly longer optical path (for example, 1 to 3 mm for measurements in biological tissues) than the sensing arm 44. The optical path difference between the two arms 42, 44 is configured such that the LCI system 10 balanced for the chosen probing depth z. Provision is also made to include a modulator m₁ 52 and m₂ 54 in the reference arm 42 and sensing arm 44 respectively.

In an exemplary embodiment, the splitter/coupler 50, Y-splitter/combiner 51 reference arm 42 and a sensing arm 44 are formed as waveguides in a substrate. However, other configurations are possible, including but not limited to separate components, waveguides, optical fiber, and the like. The substrate 23 for this module should preferably, but not necessarily, be selected such that the waveguides of the arms 42, 44 and modulators 52, 54 can be fabricated on/in it by standard lithographic and evaporation techniques. In one exemplary embodiment, the waveguides of the arms 42, 44 are fabricated by thermal diffusion of titanium or other suitable metal that increases the index of refraction of the substrate, evaporated through masks of appropriate width for single transverse-mode operation. In another exemplary embodiment, the waveguides are formed by annealed proton exchange in an acid bath. This process raises the refractive index in the diffusion region, thus creating a waveguide by virtue of the refractive index contrast between the diffusion region and the surrounding regions. In an exemplary embodiment, is lithium niobate (LiNbO3) is employed as a substrate 23. It will be appreciated that other possible materials, namely ferroelectric crystals, may be utilized such as lithium tantalite (LiTaO3) and possibly indium phosphide depending on configuration and implementation of the LCI system 10.

Lithium niobate is a ferroelectric crystal material with excellent optical transmission characteristics over a broad wavelength range from the visible to the infrared. It also has a high electro-optic coefficient, i.e., it exhibits a change of refractive index under the application of an external electric field. The refractive index change is proportional to the electric field. The speed of light in a transparent solid is slower than in vacuum because of its refractive index. When light propagates in a waveguide built into the electro-optic material, an applied electric field can alter the delay in the material, and if the electric field is time-varying, this will result in a phase modulation of the light. The LiNbO3 material is very stable, the technology for making it is mature, and LiNbO3 modulators, which can be compact and are commercially available.

In an exemplary embodiment, the high electro-optic coefficient (refractive index change with applied electric field) of lithium niobate is exploited to facilitate implementation of a modulator, such as modulators m₁ 52 and m₂ 54. In this embodiment, a modulator is implemented on or about the waveguide arms 42, 44, by depositing metal electrodes 56, 58 in close proximity to the waveguide arms. In one embodiment, the metal electrodes 56, 58 are deposited on the sides of the waveguide arms 42, 44. In another, the metal electrodes 56, 58 may be deposited on the waveguide arms 42, 44 with an appropriate insulation layer, in a selected region. FIGS. 4A and 4B also show a diagrammatic depiction of a modulators m₁ 52, m₂ 54 in each arm 42, 44 fabricated by depositing metal films (electrodes) 56 on the outside the waveguides and a larger “common” electrode 58 between them. Modulation with modulator m₁ 52 is obtained by applying a voltage between the upper electrode 56 and the common electrode 58, and modulation with modulator m₂ 54 is obtained by applying a voltage between the lower 56 and the common electrodes 58. The change of refractive index with applied voltage results in a delay or a change of optical path between for the modulated arm 52, 54. For a given applied voltage, the optical path change depends on the length of the electrodes 56, 58.

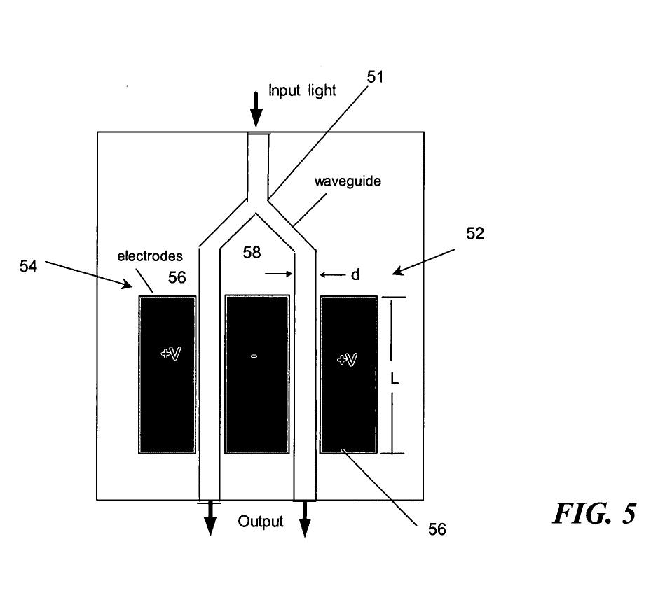

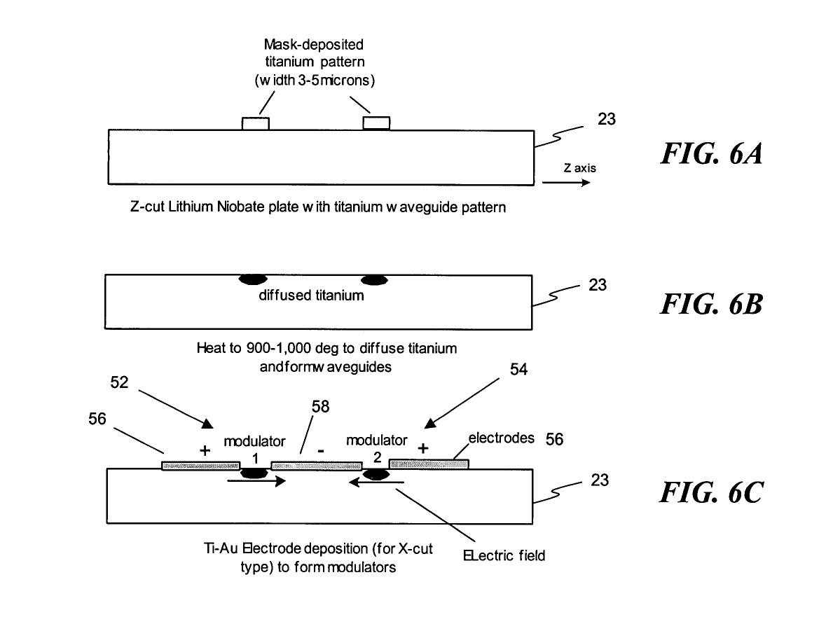

FIG. 5 depicts an illustration of a splitter-modulator module 40b with a Y-splitter 51 and two modulators 52, 54 integrated on a LiNbO3 substrate 23. One method of making the Y-splitter 51 (or splitter/combiner 50 of splitter-modulator module 40a) and waveguide arms 42, 44 is by diffusing titanium or another suitable metal into a substrate 23 at high temperature. Another method of fabrication is by proton exchange in an acid bath. In an exemplary embodiment, titanium and a lithium niobate substrate 23 are employed. The process of fabricating the module 40b (or 40a) is illustrated in FIGS. 6A-C. In the diffusion process, the waveguide pattern is etched in a mask and a thin layer of titanium is vacuum-deposited onto the substrate 23 through the mask. The substrate 23 is then heated in an oven at about 900-1000 degrees C. to diffuse the titanium into the lithium niobate substrate 23. The index of refraction of the diffusion region is slightly higher than that of the surrounding material, and this constitutes waveguides in which light is guided in the diffusion region by virtue of its higher refractive index (just as in an optical fiber where the light propagates in the higher index core). Following diffusion, the metal electrodes 56 and 58 for the modulator(s) 52, 54 are deposited on the sides as shown, with a small spacing d between them. Application of a voltage V between one of the outer electrodes 56 and the negative center electrode 58 establishes an electric field of value V/d across the waveguide e.g. reference arm 42 and/or sensing arm 44. In an exemplary embodiment, the width of the waveguide is approximately 3-5 microns, and the spacing d is only a few more microns wider.

The refractive index change due to the electro-optic effect is given by

$$Δ n = - \frac{1}{2} {n}_{o}^{3} r \frac{V}{d} \qquad ( 32 )$$

where n₀ is the refractive index, and r is the electro-optic coefficient. The phase shift of a light of wavelength λ propagating in a LiNbO3 modulator is given by

$$Δϕ = π \frac{L}{λ} {n}_{o}^{3} r \frac{V}{d} \qquad ( 33 )$$

where L is the length of the modulator electrodes 56, 58. In the context of the LCI systems 10 disclosed herein, this corresponds to an optical path length change of

$$Δ l = \frac{1}{2} {n}_{o}^{3} rL \frac{V}{d} \qquad ( 34 )$$

Typical material properties are:
r=11.3×10⁻¹² mV
n₀=2.35

To obtain larger scale modulations, it will be appreciated that an increase in the voltage on/or the length of the modulator will result in larger changes in the index of refraction by the modulator, resulting in an increased variation of the corresponding phase delay. For example, with a configuration of d=10 microns, an applied voltage of only 3.6 volts is sufficient to yield a value of Δl or b (as discussed above) of 1.3 microns (the wavelength of the light discussed in the examples above). This illustrates that a modulator with a range equivalent to the wavelength λ (for example) 1.3 microns may readily be achieved employing the configuration described.

In an exemplary embodiment, the reference arm 42 is terminated in an evaporated mirror (metal or quarter-wave stack) 46, and the sensing arm 44 is terminated in an anti-reflection (AR) coating, or is covered with an index-matching agent 48 that prevents or minimizes reflection from the end of the sensing arm 44 when placed in contact with the object to be measured. In such a configuration splitter-modulator module 40 would be on the order of about 2 cm×2 cm×0.5 cm.

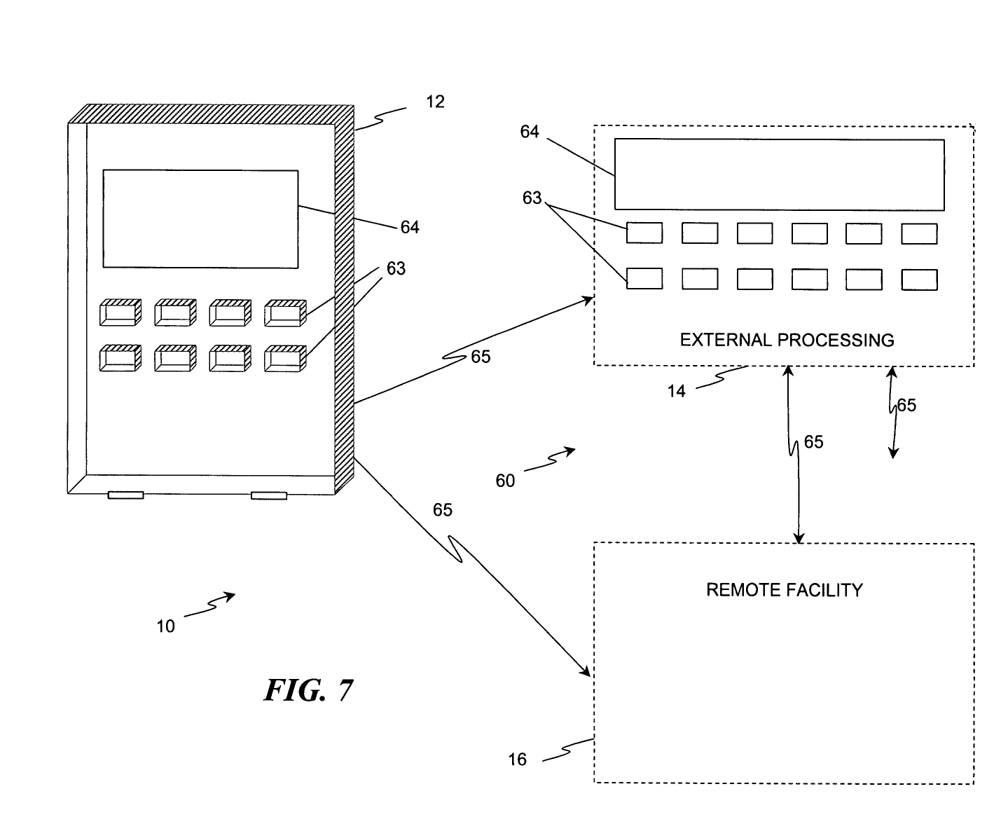

Referring now to FIG. 7, a miniaturized, optionally handheld, LCI system 10 is depicted in accordance with an exemplary embodiment. In an exemplary embodiment, the LCI system 10 is packaged in a small enclosure 12 and includes, but is not limited to, various modules including, but not limited to source-detector module 20a, 20b, splitter-modulator module 40a, 40b and may include one or more additional extension, adapter or interface modules such as 80, 90, and 92 (See FIGS. 4A and 4B and 9-12) or even calibration strip 70. In addition, also optionally packaged within the enclosure may be processing system 60, including processor 62 (not shown in this view) associated controls 63 e.g., keys, selectors, pointers, and the like, display 64, data media 66, as well as communication interfaces 65, and the like as well as rechargeable batteries. Therefore, in one exemplary embodiment the LCI system 10 as packaged in enclosure 12 should be comparable in size to that of a typical cell phone or a Personal Digital Assistant (PDA), i.e., about 4 cm×6 cm×1 cm. to readily facilitate handheld operation.

Continuing with FIG. 7, it should also be appreciated as mentioned earlier, that various portions of the LCI system 10, and particularly, processing system 60 may be enclosed within the enclosure 12, or associated with an external processing unit 14, or remotely located, such as with a computer processing system 60 in another facility 16. In yet another exemplary embodiment, the LCI system 10 may also include communication interfaces 65, including wireless interfaces (e.g., infrared, radio frequency, or microwave transmitter/receiver) similar to modern computers, cell phones, PDAs, and the like to enable communication, including, but not limited to Internet communication, with external systems 14 and remote facilities 16. For example, as a non-patient monitor and controller, a sensing portion including the source-detector module 20a, 20b and splitter-modulator module 40a, 40b can be detachable, in the form of a wrist band or wrist watch for continuous monitoring, while the rest of the remainder of the LCI system 10 may be in a patient's pocket, separate computer, at a doctor's office, and the like.

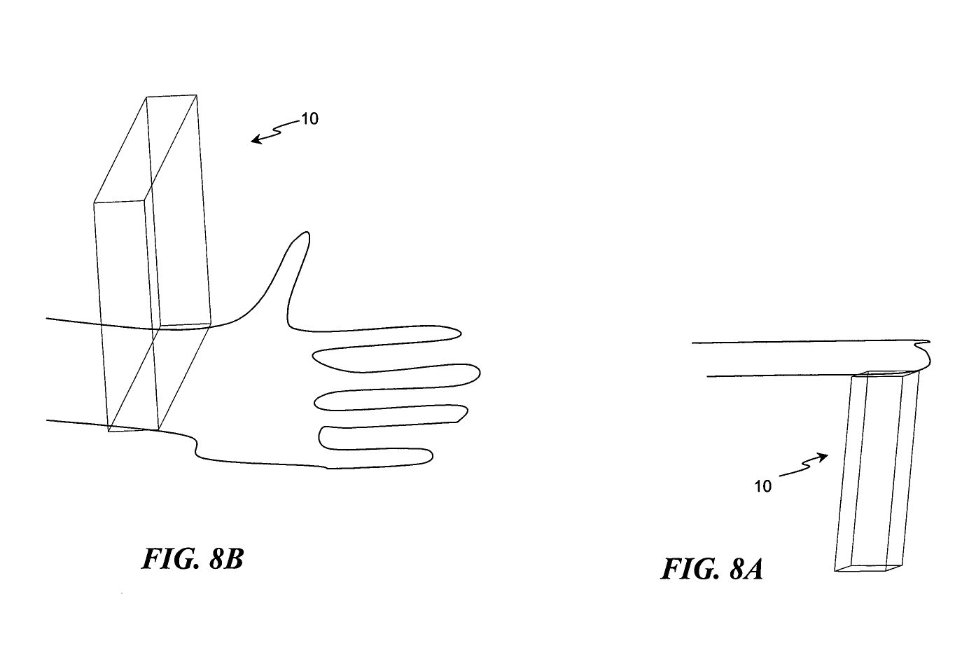

Referring now to FIGS. 8A and B, to illustrate operation of the LCI system 10, as a monitor, the instrument is placed against the biological sample, e.g., a patient. The LCI system 10 would rapidly measure and determine the desired parameter, (or a multitude of measurements can be made and averaged over a few seconds). A display 66 may also be utilized to provide visual information with respect to the measurement. Furthermore, in another exemplary embodiment, the LCI system 10 could be coupled to a dispenser, possibly embedded in the patient, for real-time control and administration of medications.

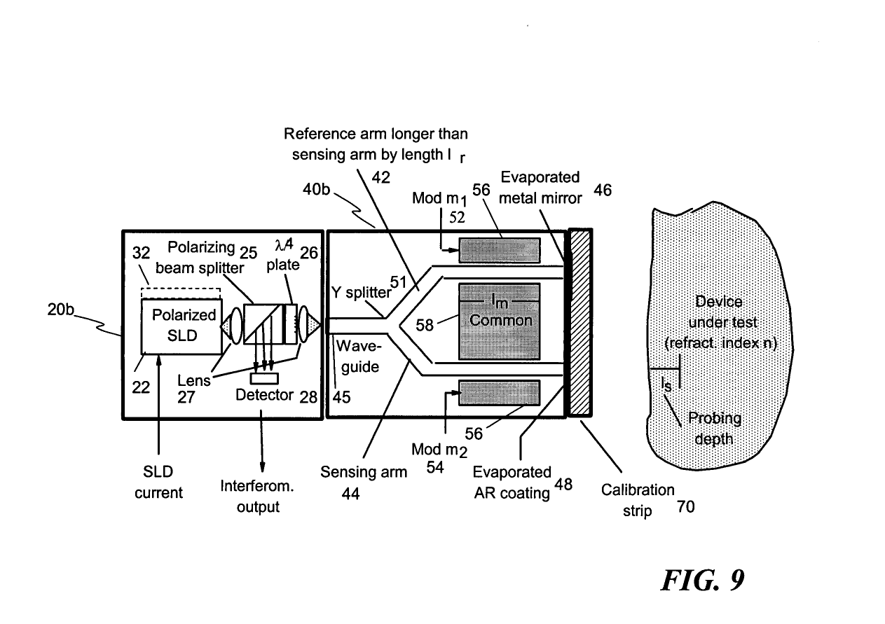

The magnitude and/or phase associated with a selected length of the reference arm is pre-calibrated to correspond to a set distance (about 1 to 3 mm) under the skin. The spot size for the light at the tip of the sensing fiber or waveguide of the sensing arm 44 is on the order of a few microns. The LCI system 10 may readily be calibrated by placing a strip of known refractive index (or, in the case of a patient monitor, known characteristics), and appropriate thickness at the sensing end of the splitter-modulator module 40 before performing a measurement. FIG. 9 depicts the LCI system of FIGS. 4A and 4B with a calibration strip in place. The calibration strip 70 can serve the dual purpose of calibration and refractive index matching. Its placement in contact with the splitter-modulator module 40a, 40b does not affect the reference arm 42, since the reference arm light does not penetrate it due to the presence of the end mirror 46. The calibration strip 70 and associated processing may be configured such that the LCI system 10 provides a first reading when the calibration strip 70 is not in contact with the LCI system 10 and a corrected reading when in contact with the calibration strip. Furthermore, the calibration strip may be configured as a disposable item.

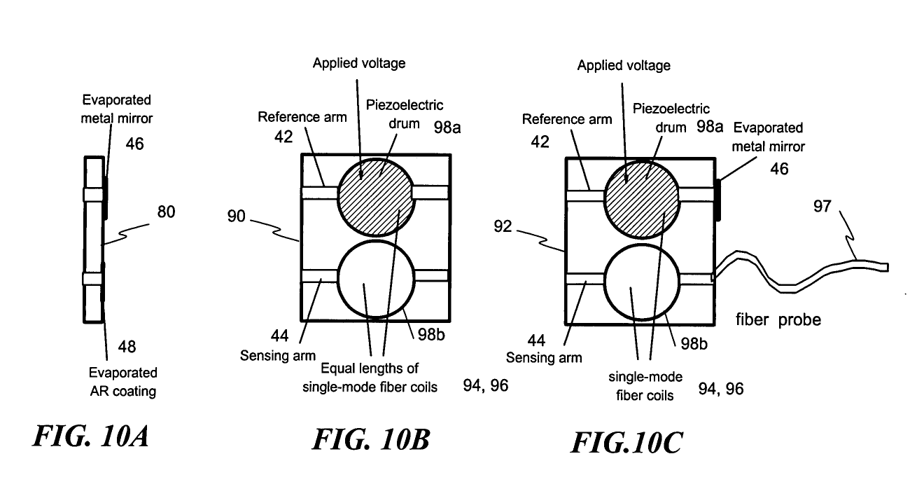

The configuration described above with reference to FIGS. 4A and 4B is convenient to use when the instrument can be placed directly in contact with the sample to provide a reading for a selected depth. Some applications may require the probing depth to be dynamic to enable locating a feature. For example, in medical diagnostics or imaging, the operator may need to probe for features such as tumors, characterized by large changes of optical properties (absorption, reflection, or refractive index change due to a different density). Some other (medical) applications may require a probe to be inserted into the body or object under study. For example, employing an expansion to the embodiments disclosed herein with a fiber probe with a catheter and guide wire to facilitate internal diagnostics and imaging. FIGS. 10A-10C depict an adapter and several expansion or extension modules 90, 92, which can be attached to the LCI system 10 of FIGS. 4A and 4B to provide additional versatility and functionality. FIG. 10A, depicts an adapter 80, configured, in one exemplary embodiment as a short section of waveguides 82, preferably, but not necessarily, made of the same material as the splitter-modulator 40a, 40b, with mirror 46 and AR coating 48, which can be attached to the splitter-modulator 40a, 40b (with matching fluid) to operate as an interface for various extension modules 90, 92. The purpose of the extension module 90 is to provide for adequate lengths of the reference and sensing arms 42, 44 while using a minimum of space, and for adjusting the length of the reference arm 42 and/or sensing arm 44 to enable probing at various depths. The length of the arms 42, 44 can be adjusted in any number of ways, including mechanically changing an air gap between two sections of the reference arm, moving the mirror 46, actually modifying the length of the arm, and the like, as well as combinations including at least one of the foregoing. A preferred way to manipulate the length of an arm 42, 44, in this instance the reference arm 42, in order to maintain small size, accuracy, and stability, is to perform this operation electromechanically.

Referring now to FIGS. 10B and 10C, in yet another exemplary embodiment, an extension modules 90 and 92 including windings of two lengths of single-mode fibers 94, 96, preferably a polarization maintaining fiber (PMF), (reference and sensing arms respectively) on two drums 98a and 98b. In one embodiment, the drum for the reference arm 42 is made out of a piezoelectric material such as, but not limited to PZT (lead zirconate titanate). The diameter of the drums is selected to be large enough to prevent radiation from the fibers 94, 96 due to the bending for example, about 3-4 centimeters (cm). The diameter of the fibers 94, 96 with claddings is of the order of 0.12 mm. The application of a voltage to the PZT drum 98a causes it to expand or contract, thus straining the reference fiber 94 (for example) and changing its effective length and thereby the optical path length for the reference arm 42. Therefore, as the total length of the unstrained fiber is increased, the total expansion increases as well. For example, if the strain limit for the fiber 94 is about Δl/l is 10⁻⁴, then it requires a 10-meter length of fiber 94 to provide for about a 1 mm extension. Advantageously, a length tens of meters is relatively easy to achieve if the fiber 94 is not too lossy. In the 1.3 μm to 1.55 μm wavelength range, the absorption in optical fibers 94, 96 is of the order of 0.2 dB/Km. There for the losses associated with a 10 meter length would be quite small. Thus, the approach of using a voltage applied a piezoelectric drum e.g., 98a wound with a fiber 94 coil is an effective means to provide changes of several millimeters in the optical path length of the reference arm 42.

Continuing with FIGS. 10B and 10C, the extension module 90 is configured to provide the extension of the reference and sensing arms 42 and 44 as described above and interfaces with an adapter 80 to facilitate depth profiling. Extension module 92 also includes an evaporated metal mirror 46 to terminate the reference arm 42, while the sensing arm 44 is terminated with a fiber probe 97 configured to facilitate probing such as may include a guidewire and catheter.

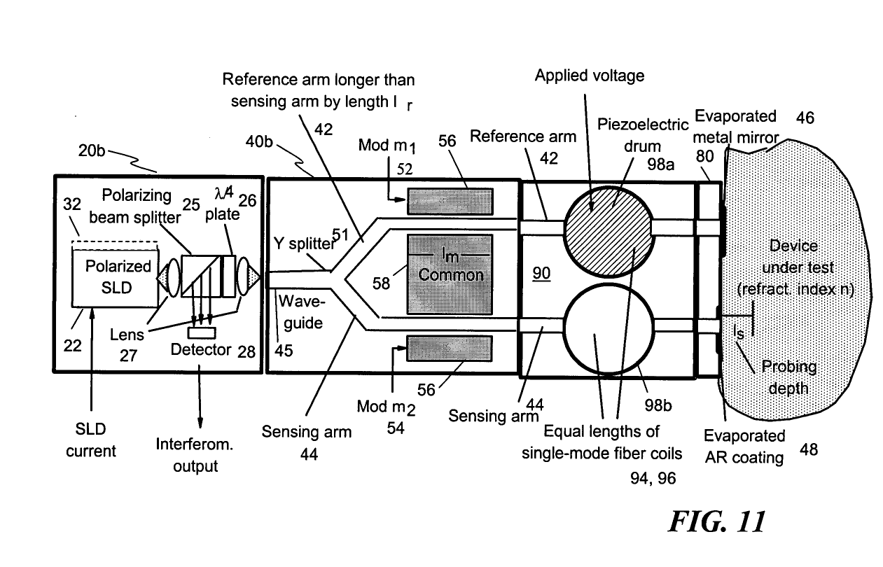

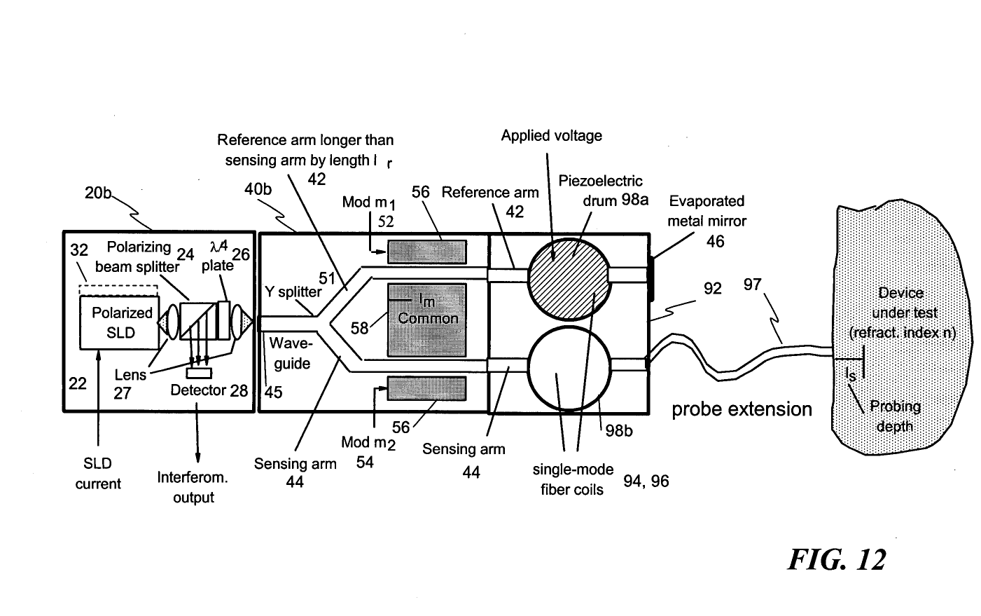

FIGS. 11 and 12 depict various implementations of the extended instrument starting from the base configuration depicted in FIGS. 4A and 4B and using the adapter and the extension modules 80, 90, and 92. FIG. 11 depicts a configuration of an exemplary embodiment where in addition to the source-detector module 20a, 20b and splitter modulator module 40a, 40b and extension module 90 and adapter 80 are employed. This configuration facilitates probing at various depths as well as facilitating depth profile scanning. FIG. 12 depicts a configuration of another exemplary embodiment where in addition to the source-detector module 20 and splitter modulator module 40 and extension module 92 including an external probe 97 are employed. This configuration facilitates probing either at a distance from the device or remote probing such as with a catheter and guidewire. FIG. 11 depicts a configuration of an exemplary embodiment where in addition to the source-detector module and splitter modulator module 40a, 40b and extension module 90 and adapter 80 are employed. This configuration facilitates probing at various depths as well as facilitating depth profile scanning.

The disclosed invention can be embodied in the form of computer, controller, or processor implemented processes and apparatuses for practicing those processes. The present invention can also be embodied in the form of computer program code containing instructions embodied in tangible media 66 such as floppy diskettes, CD-ROMs, hard drives, memory chips, or any other computer-readable storage medium, wherein, when the computer program code is loaded into and executed by a computer, controller, or processor 62, the computer, controller, or processor 62 becomes an apparatus for practicing the invention. The present invention may also be embodied in the form of computer program code as a data signal 68 for example, whether stored in a storage medium, loaded into and/or executed by a computer, controller, or processor 62 or transmitted over some transmission medium, such as over electrical wiring or cabling, through fiber optics, or via electromagnetic radiation, wherein, when the computer program code is loaded into and executed by a computer 62, the computer 62 becomes an apparatus for practicing the invention. When implemented on a general-purpose processor the computer program code segments configure the processor to create specific logic circuits.

It will be appreciated that the use of first and second or other similar nomenclature for denoting similar items is not intended to specify or imply any particular order unless otherwise stated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for optical metrology of a biological sample, said system comprising:
a broadband light source for providing a broadband light;
an optical assembly receptive to said broadband light, said optical assembly configured to facilitate transmission of said broadband light in a first direction and impede transmission of said broadband light a second direction, said optical assembly generally maintaining low coherence of said broadband light;
a sensing light path receptive to said broadband light from said optical assembly, said sensing light path configured to direct said broadband light at the biological sample and to receive said broadband light reflected from the biological sample;
a fixed reflecting device;
a reference light path receptive to said broadband light from said optical assembly, said reference light path configured to direct said broadband light at said fixed reflecting device and to receive said broadband light reflected from said fixed reflecting device, said reference light path coupled with said sensing light path to facilitate interference of said broadband light reflected from the biological sample and said broadband light reflected from said fixed reflecting device, said reference light path having an effective light path length longer than an effective light path length of said sensing light path by a selected length corresponding to about a selected target depth within the biological sample; and
a detector receptive said broadband light resulting from interference of said broadband light reflected from the biological sample and said broadband light reflected from said fixed reflecting device to provide an electrical interference signal indicative thereof.

2. The system of claim 1 wherein:
said broadband light has a first polarization; and
said optical assembly comprises,
a beam splitter configured to facilitate transmission of said broadband light received from said broadband light source in said first direction based said first polarization, said first direction being from said broadband light source, said beam splitter further configured to impede transmission of said broadband light resulting from interference of said broadband light reflected from the biological sample and said broadband light reflected from said fixed reflecting device in said second direction based on a second polarization, said second direction being towards said broadband light source, and
a quarter-wave plate receptive to said broadband light resulting from interference of said broadband light reflected from the biological sample and said broadband light reflected from said fixed reflecting device, said quarter-wave plate configured to induce said second polarization on said broadband light resulting from interference of said broadband light reflected from the biological sample and said broadband light reflected from said fixed reflecting device.

3. The system of claim 2 wherein said beam splitter is further configured to facilitate transmission of said broadband light resulting from interference of said broadband light reflected from the biological sample and said broadband light reflected from said fixed reflecting device in a third direction based on said second polarization, said third direction being toward said detector, said beam splitter further configured to impede transmission of said broadband light received from said broadband light source in said third direction based said first polarization.

4. The system of claim 2 wherein said quarter-wave plate is further receptive to said broadband light transmitted from said beam splitter, said quarter-wave plate is configured to induce a third polarization on said broadband light transmitted from said beam splitter.

5. The system of claim 2 wherein said first polarization comprises one of horizontal polarization and vertical polarization, and said second polarization is another of said horizontal polarization and said vertical polarization.

6. The system of claim 1 wherein said optical assembly impedes transmission of said broadband light to less than or equal to about 10^{-3.}

7. The system of claim 6 wherein said optical assembly impedes transmission of said broadband light to less than or equal to about 10⁻⁴.

8. The system of claim 1 wherein:
said broadband light has a first polarization; and
said optical assembly comprises,
an isolator configured to facilitate transmission of said broadband light received from said broadband light source in said first direction based said first polarization, said first direction being from said broadband light source, said isolator further configured to impede transmission of said broadband light resulting from interference of said broadband light reflected from the biological sample and said broadband light reflected from said fixed reflecting device in said second direction based on a second polarization, said second direction being towards said broadband light source.

9. The system of claim 1 wherein said broadband light source comprises a super-luminescent diode.

10. The system of claim 1 wherein said optical assembly generally maintains an output power level of said broadband light.

11. The system of claim 1 wherein said reference light path coupled with said sensing light path comprises a splitter/combiner.

12. The system of claim 1 wherein at least one of said sensing light path and said reference light path are comprised of at least one of an optical fiber and a waveguide.

13. The system of claim 12 further comprising a substrate having said waveguide formed therein by thermal diffusion of metal ions evaporated through masks having a width for single transverse-mode operation.

14. The system of claim 13 wherein said metal increases an index of refraction of said substrate.

15. The system of claim 14 wherein said metal comprises titanium.

16. The system of claim 12 wherein said waveguide is formed by annealed proton exchange in an acid bath.

17. The system of claim 12 wherein said substrate is substantially comprised of lithium niobate.

18. The system of claim 12 wherein said substrate is substantially comprised of at least one of lithium tantalite and indium phosphide.

19. The system of claim 12 wherein said at least one of said optical fiber and said waveguide are configured for single transverse-mode transmission.

20. The system of claim 12 wherein said at least one of said optical fiber and said waveguide are configured to maintain polarization of said broadband light therein.

21. The system of claim 12 wherein said at least one of an optical fiber and an optical waveguide are configured to minimize reflection.

22. The system of claim 1 further comprising a modulator associated with at least one of said reference light path and said sensing light path for manipulating said effective light path length thereof.

23. The system of claim 22 wherein said modulator comprises metallic electrodes deposited at said at least one of said waveguide reference light path and said waveguide sensing light path.

24. The system of claim 22 wherein said modulator comprises an optical fiber circumferentially wound around a piezoelectric drum, wherein said piezoelectric drum increases a length of said optical fiber upon application of a voltage to said piezoelectric drum and thereby increasing said effective light path length thereof.

25. The system of claim 1 further comprising a calibration strip having a known refractive index.

26. The system of claim 1 further comprising a processing system in operable communication with said detector, said processing system configured for processing said electrical interference signal.

27. The system of claim 26 said processing system further configured for controlling said system.

28. The system of claim 26 wherein said processing system is, at least in part, packaged integral with the rest of said system.

29. The system of claim 26 wherein said processing system includes a controller and an associated display.

30. The system of claim 1 wherein said system is configured and packaged as a portable instrument.

31. The system of claim 30 wherein said portable instrument has a volume less than about 0.5 cubic feet.

32. The system of claim 30 wherein said system is configured and packaged as a handheld instrument.

33. The system of claim 32 wherein said handheld instrument has a volume of less than about 24 cubic inches.

34. The system of claim 33 wherein said handheld instrument has a volume of less than about 4 cubic inches.

35. The system of claim 1 wherein said system is modular with a handheld measurement part and a remote processing part.

36. The system of claim 1 wherein said system is configured to interface with a remote system.

37. The system of claim 1 further comprising an extension module to extend said reference light path and said sensing light path.

38. The system of claim 37 wherein said extension module includes a modulator for manipulating at least one of said effective light path length of said reference light path and said effective light path length of said sensing light path.

39. The system of claim 37 wherein said modulator comprises an optical fiber circumferentially wound around a piezoelectric drum, wherein said piezoelectric drum increases a length of said optical fiber upon application of a voltage to said piezoelectric drum and thereby increasing said effective light path length thereof.

40. The system of claim 39 wherein said optical fiber comprises a polarization-maintaining optical fiber.

41. The system of claim 38 wherein said fixed reflecting device is disposed at said extension module with extended said reference light path terminating thereat, and said extension module further including an optical fiber probe to extend said sensing light path.

42. The system of claim 12 wherein said optical fiber includes an antireflective coating at a distal end thereof.

43. The system of claim 1 further comprising a thermoelectric cooler associated with said broadband light source to maintain a temperature thereof below a threshold.

44. The system of claim 1 wherein said system is configured to be a modular system.

45. The system of claim 1 wherein said modular system includes:
a first module including said broadband light source, said optical assembly, and said detector; and
a second module including said sensing light path, said fixed reflecting device, and said reference light path.

46. A method for optical metrology of a biological sample, the method comprising:
providing a broadband light by means of a broadband light source;
facilitating transmission of said broadband light in a first direction and impeding transmission of said broadband light a second direction, while generally maintaining low coherence of said broadband light;
directing said broadband light by means of a sensing light path at the biological sample, said sensing light path having an effective light path length;
receiving said broadband light reflected from the biological sample by means of said sensing light path;
directing said broadband light by means of a reference light path at a fixed reflecting device, said reference light path having an effective light path length, said effective light path length of said reference light path being longer than said effective light path length of said sensing light path by a selected length corresponding to about a selected target depth within the biological sample;
receiving said broadband light reflected from said fixed reflecting device by means of said reference light path;
interfering said broadband light reflected from the biological sample and said broadband light reflected from said fixed reflecting device; and
detecting said broadband light resulting from interference of said broadband light reflected from the biological sample and said broadband light reflected from said reflecting device to provide an electrical interference signal indicative thereof.

47. The method of claim 46 wherein:
said broadband light has a first polarization;
said facilitating transmission of said broadband light comprises facilitating transmission of said broadband light from said broadband light source in said first direction based said first polarization, said first direction being from said broadband light source; and
said impeding transmission of said broadband light comprises impeding transmission of said broadband light resulting from said interfering of said broadband light reflected from the biological sample and said broadband light reflected from said fixed reflecting device in said second direction based on a second polarization, said second direction being towards said broadband light source.

48. The method of claim 47 further comprising:
inducing said second polarization on said broadband light resulting from said interfering of said broadband light reflected from the biological sample and said broadband light reflected from said fixed reflecting device.

49. The method of claim 48 wherein:
said facilitating transmission of said broadband light further comprises facilitating transmission of said broadband light resulting from said interfering of said broadband light reflected from the biological sample and said broadband light reflected from said fixed reflecting device in a third direction based on said second polarization, said third direction being toward a detector for said detecting; and
said impeding transmission of said broadband light further comprises impeding transmission of said broadband light received from said broadband light source in said third direction based said first polarization.

50. The method of claim 48 further comprising:
inducing a third polarization on said broadband light transmitted resulting from said interfering of said broadband light reflected from the biological sample and said broadband light reflected from said fixed reflecting device.

51. The method of claim 48 wherein said first polarization comprises one of horizontal polarization and vertical polarization, and said second polarization is another of said horizontal polarization and said vertical polarization.

52. The method of claim 46 wherein said impeding transmission of said broadband light comprises impeding to less than or equal to about 10⁻³.

53. The method of claim 52 wherein said impeding transmission of said broadband light comprises impeding to less than or equal to about 10⁻⁴.

54. The method of claim 46 wherein said broadband light source comprises a super-luminescent diode.

55. The method of claim 46 wherein said facilitating transmission of said broadband light in said first direction and said impeding transmission of said broadband light said second direction, further comprises while generally maintaining an output power level of said broadband light.

56. The method of claim 46 wherein at least one of said sensing light path and said reference light path are comprised of at least one of an optical fiber and a waveguide.

57. The method of claim 56 further comprising maintaining polarization of said broadband light in said at least one of said optical fiber and said waveguide.

58. The method of claim 56 further comprising minimizing reflection in said at least one of an optical fiber and an optical waveguide.

59. The method of claim 46 further comprising:
modulating said effective light path length of at least one of said reference light path and said sensing light path.

60. The method of claim 46 further comprising calibrating relative to a known refractive index.

61. The method of claim 40 further comprising processing said electrical interference signal.

62. The method of claim 46 further comprising interfacing said electrical interference signal with a remote system.

63. The method of claim 46 further comprising extending said reference light path and said sensing light path.

64. The method of claim 46 further comprising maintaining generally a temperature of said broadband light source below a threshold.
